(19) United States
(12) Patent Application Publication
(10) Pub. No.: US 2007/0170895 A1
(43) Pub. Date: Jul. 26, 2007

(54) Battery charging with superwaves

(76) Inventors: Irving I. Dardik, Califon, NJ (US); Vitaly Krakov, Arad (IL); Shaul L. Lesin, Meitar (IL); A. Shapiro, Beer-Sheva (IL); I. Zilberman, Meitar (IL); Tanya Zilov, Arad (IL); Arik El-Boher, Meitar (IL); Herman D. Branover, New York, NY (US)

Correspondence Address: FISH & NEAVE IP GROUP;ROPES & GRAY LLP, 1211 AVENUE OF THE AMERICAS, NEW YORK, NY, 10036-8704, US

(21) Appl. No.: 11/698,693

(22) Filed: Jan. 25, 2007

Related U.S. Application Data
(60) Provisional application No. 60/762,350, filed on Jan. 25, 2006.

(51) Int. Cl. H02J 7/04

(52) U.S. Cl. 320/150

(57) ABSTRACT

Apparatus and methods are provided for charging rechargeable batteries using amplitude and frequency modulated current.

This application claims the benefit of U.S. provisional patent application No. 60/762,350, filed Jan. 25, 2006, which is hereby incorporated by reference herein in its entirety.

### BACKGROUND OF THE INVENTION

Rechargeable batteries may typically require a certain amount of time to be charged to full capacity or close to full capacity. Rechargeable batteries may also typically have a certain number of cycles after which they can no longer be charged.

If input current is increased, then charging time can typically be reduced. However, if input current is increased too much, or at least over a certain threshold, the number of cycles of battery life may typically be reduced as well.

It is therefore an object of this invention to reduce charging time of a battery, while maintaining, or even increasing, the typical number of life cycles of the battery.

### SUMMARY OF THE INVENTION

In accordance with the invention, there is provided a method of charging a rechargeable battery. The method can include applying “SuperWaves,” amplitude and frequency modulated electrical power, to the battery, monitoring at least a first characteristic parameter of the charging process during the charging, comparing at least the first characteristic parameter with corresponding stored sets of reference parameters representing fully charged battery conditions, selecting, based on the comparison, one of the stored sets of reference parameters, and terminating the charging process when at least the first characteristic parameter has reached or exceeded the one of the stored sets of reference parameters.

### BRIEF DESCRIPTION OF THE DRAWINGS

The above and other advantages of the invention will be more apparent upon consideration of the following detailed description, taken in conjunction with the accompanying drawings, in which like reference characters refer to like parts throughout, and in which:

FIG. 1 schematically illustrates superwaving wave phenomena according to the invention;

FIGS. 2-5 illustrate algorithms of multilevel modulated oscillations according to the invention;

FIG. 6 is a chart of a typical “SuperWaves” charging pattern according to the invention;

FIG. 7 is a layout of an experimental set-up for charging-discharging battery tests at DC and “SuperWaves” modulated current according to the invention; and

FIG. 8 shows the rates of capacity deterioration for a tested battery charged by “SuperWaves” modulated current according to the invention and for a tested battery charged by DC.

### DETAILED DESCRIPTION OF THE INVENTION

Superwaving:

The present invention can provide for reduced charging time of a battery while at least substantially maintaining the typical number of life cycles for that battery. In a preferred embodiment of the invention, a battery may be charged through the application of current (electrical) pulses. However, these pulses are not of constant amplitude and duration but are in a pattern in which the amplitude and duration of the pulses and the intervals therebetween may be as in superwaves to provide more efficient charging of the battery.

This pulse pattern is in accordance with superwaving wave activity as set forth in the theory advanced in the Irving I. Dardik article “The Great Law of the Universe” that appeared in the March/April 1994 issue of the “Cycles” Journal. This article is incorporated herein by reference.

In nature, changes in the frequency and amplitude components of a wave are not independent and different from one another, but may be concurrently one and the same, representing two different hierarchical levels simultaneously. Any increase in wave frequency at the same time can create a new wave pattern, for all waves incorporate therein smaller waves and varying frequencies, and one cannot exist without the other.

Every wave may necessarily incorporate smaller waves, and can be contained by larger waves. Thus each high-amplitude low-frequency major wave can be modulated by many higher frequency low-amplitude minor waves. Superwaving may be an ongoing process of waves waving within one another.

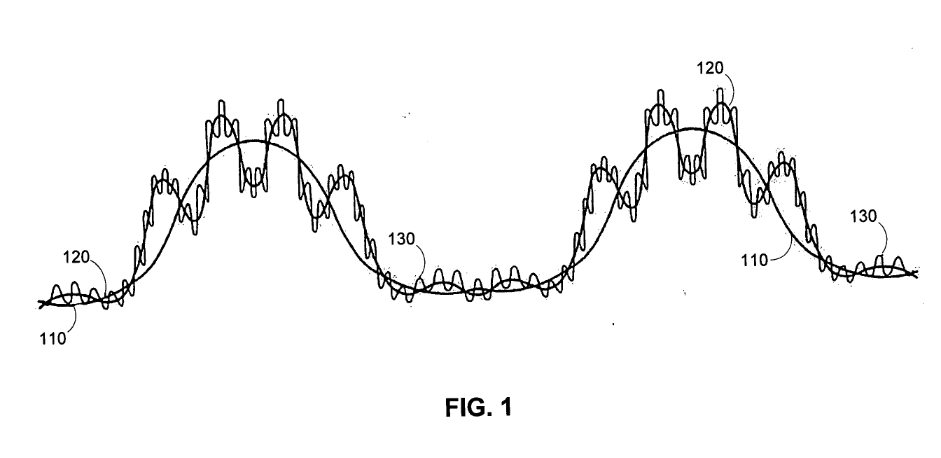

FIG. 1 (adapted from the illustrations in the Dardik article) schematically illustrates superwaving wave phenomena. FIG. 1, for example, depicts low-frequency major wave 110 modulated, for example, by minor waves 120 and 130. Minor waves 120 and 130 have progressively higher frequencies (compared to major wave 110). Other minor waves of even higher frequency may modulate major wave 110, but are not shown for clarity.

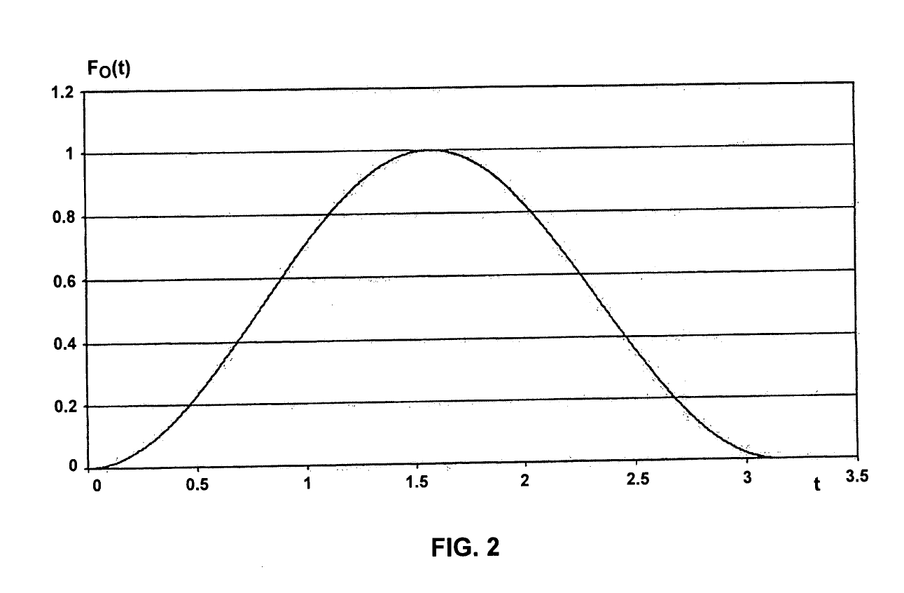

The algorithm of the generation of a “waving wave,” or “SuperWaves,” type signal is relatively simple. A carrier oscillation may be singled out and described as:
F₀(t)=A₀ sin²(ω₀t+φ₀) (1)
An example of such a carrier oscillation may be shown in FIG. 2, for example, wherein A₀=1, ω₀=1, φ₀=0. By superimposing an amplitude modulation, the resulting oscillation may acquires the form:
F₀(t)=A₀ sin²(ω₀t)(1+A₁ sin²(ω₁t)) (2).

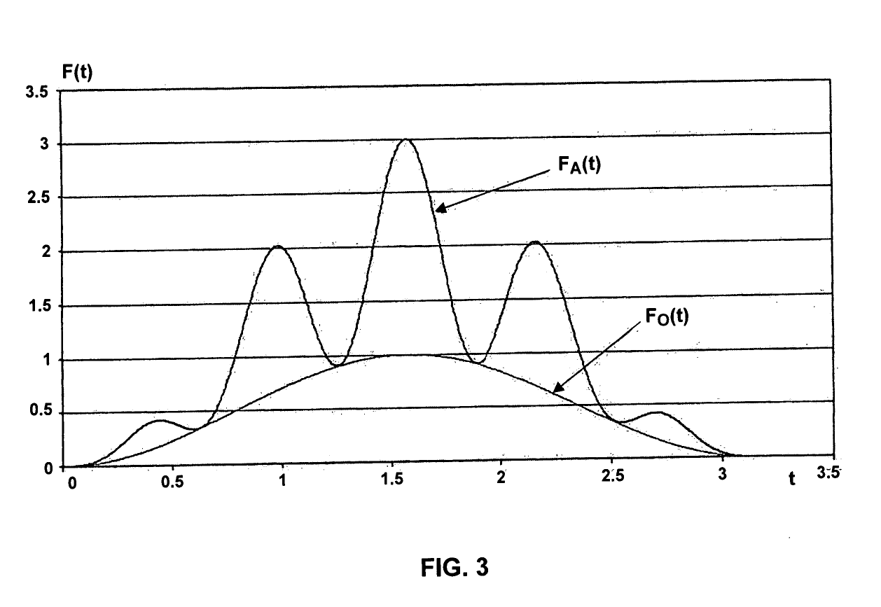

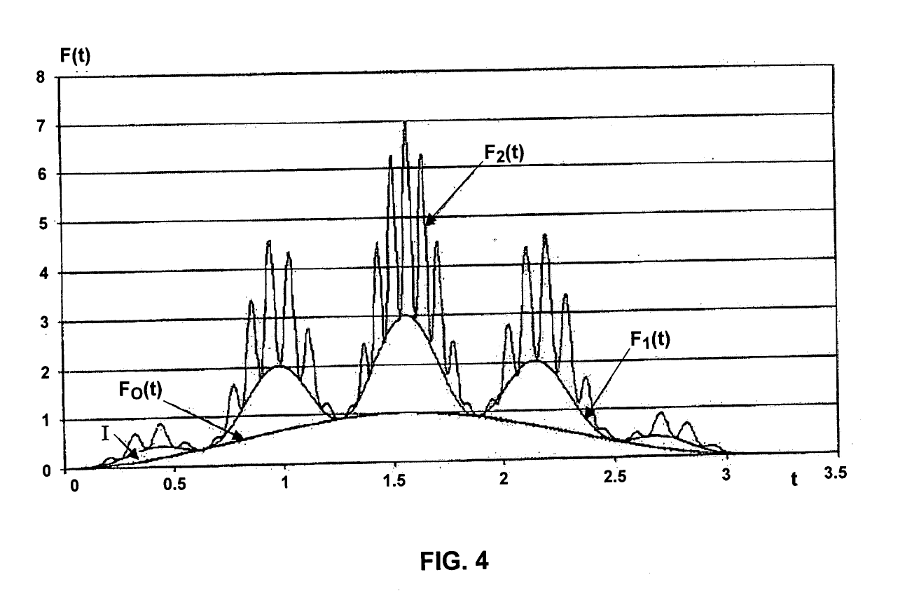

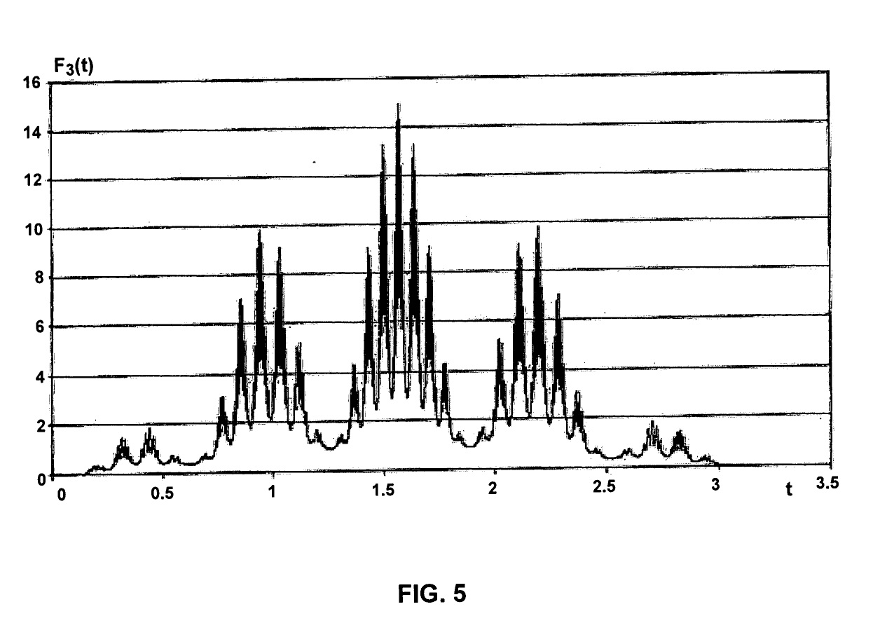

FIG. 3, for example, may show the amplitude modulation of a basic signal F₀(t), wherein n₁(=ω₁/ω₀)=5, A₁=1. The second and the third modulation levels can include a similar procedure and may be described as:
F₂(t)=A₀ sin²(ω₀t)(1+A₂ sin²(ω₁t)(1+A₂ sin²(ω₂t))) (3) and
F₃(t)=A₀ sin²(ω₀t)(1+A₁ sin²(ω₁t)(1+A₂ sin²(ω₂t)(1+A₃ sin²(ω₃t)))) (4)
These modulated signals are presented in FIGS. 4 and 5, respectively, for example.

Additionally, such an amplitude modulated signal can be modified by frequency modulation. In such an instance, the parameters of frequency modulation can be chosen such that the maximal frequency of the modulated signal coincides with the range of maximal amplitudes, and such that the minimal frequency of the modulated signal coincides with the range of minimal amplitudes. The frequency modulation procedure, like that of an amplitude modulation, can be repeated a great number of times to construct high-level modulations.

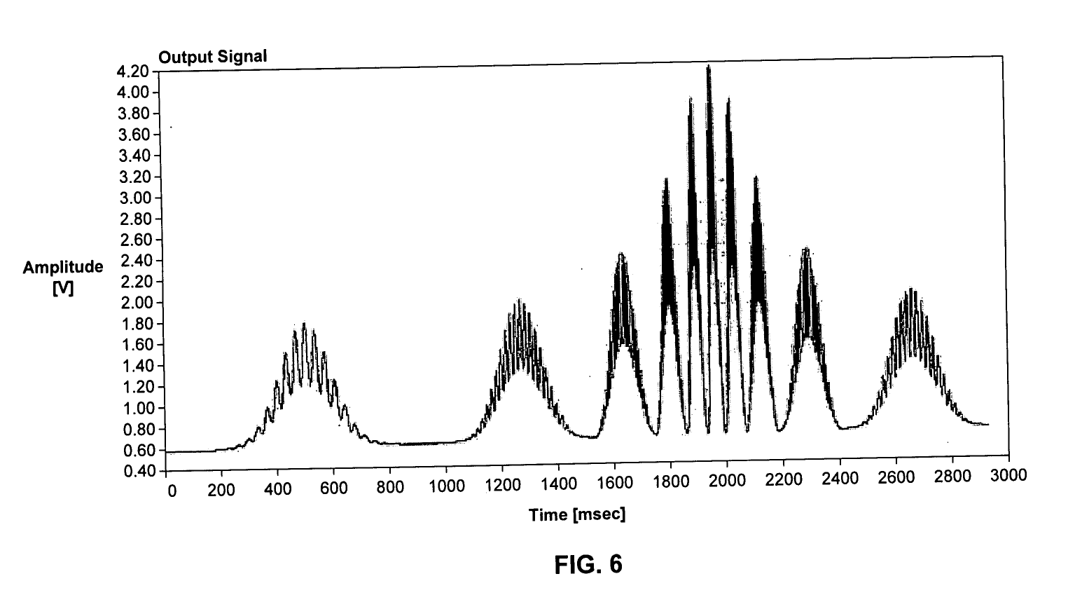

In certain embodiments of the invention, a multi-level algorithm may be applied for “SuperWaves” generation. The typical shape of the “SuperWaves” modulated signal, applied in certain embodiments of the invention, is shown in FIG. 6, for example.

“SuperWaves” activity has been used before in a variety of applications. Examples of these applications have been set forth in U.S. patent application Ser. Nos. 10/161,158, 10/738,910, 10/916,846, and 11/061,917, all of which are incorporated by reference herein in their respective entireties.

Nevertheless, “SuperWaves” activity has not heretofore been applied to battery charging technology. The present invention applies the superwaving phenomenon to battery charging. Furthermore, the invention can provide a feedback mechanism by which a charging gradient, for example voltage or temperature with time (i.e., dV/dt or dT/dt), may be determined. Based on the charging gradient, one or more parameters by which the superwaving is implemented can be modified as needed.

It should be noted that implementing the superwaves in the charging may substantially improve the efficiency of the charging. By using the informational feedback loop to further increase the efficiency of the charging, substantial decreases in charging time may occur without diminishing, or even while increasing, the number of life cycles of the battery.

The Battery:

The use of “SuperWaves” patterns to charge a battery is described herein with respect to a nickel metal hydride (NiMH) battery, by way of example, and without limitation of the invention to this particular battery type. Due to their high energy density, and due to the fact that they may contain no toxic metals, NiMH batteries are found in various applications, including, but not limited to, mobile phones, laptop computers, and digital cameras. On the other hand, this battery type is generally characterized by limited service life, if repeatedly deep cycled, especially at high load currents, and the performance starts to deteriorate after 200 to 300 cycles.

Various tests have been executed in accordance with the present invention using rechargeable NiMH “GP” 2500 batteries of the AA type with a rated capacity of 2500 mAh. Before starting the charging-discharging cycles, the tested and referenced batteries were refreshed by using a standard battery smart La Crosse BC-900 charger.

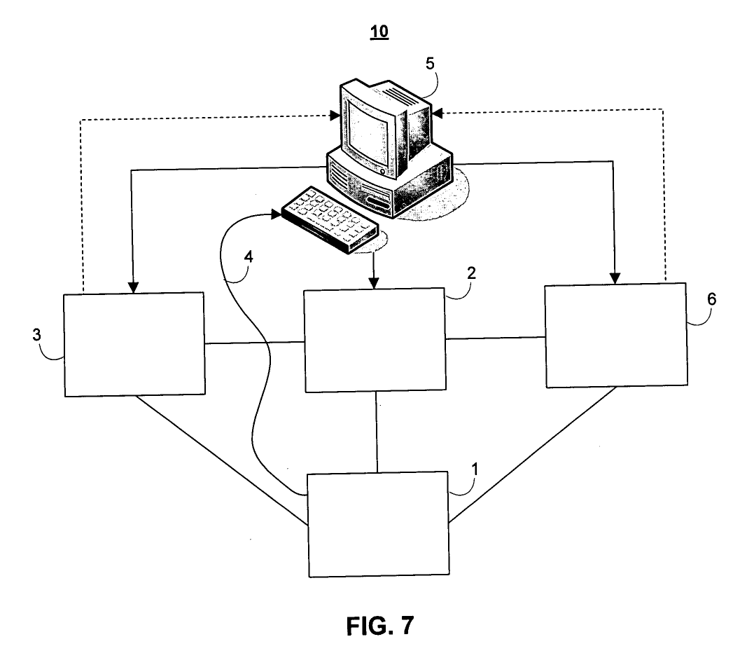

In order to compare the effect of “SuperWaves” charge, a 4-channel charge-discharge work-station was assembled that can test two pairs of batteries simultaneously. One pair of batteries was charged by a “SuperWaves” modulated current, while the second pair was charged by DC current. Operation of the equipment and data acquisition for all the channels was provided by one computer PC using Labview software. An experimental system setup 10 for charging-discharging battery tests according to the invention is shown in FIG. 7, for example. System 10 can include a rechargeable battery 1, a switcher 2, a power supply 3, a thermocouple 4, a personal computer 5 with data acquisition cards, and an electronic load 6, for example.

In one experiment, two tested batteries were charged by a “SuperWaves” modulated current, generated by the computer 5 and amplified by two power supplies 3 at constant current mode, while two reference batteries 1 were charged by a 2-channel DC power supply 3. The average value of the modulated current was set equal to the DC current.

It is generally accepted that batteries can be safely charged at 0.1 of their rated capacity “C” per hour. For example, a 2500 mAh cell can be charged at 250 mA without giving rise to damaging internal heat inside.

Therefore, in order to show the advantage of “SuperWaves” modulated charging current, an increased 0.2 C average current for the reference as well as for the tested batteries were applied for providing accelerated charging. It is an object of this invention to provide a high battery's charging rate without shortening the batteries life. Discharge of all the batteries was carried out by 4 separate electronic loads 6 at DC. The tested and reference batteries were compared according to the rate of deterioration of their capacity, which was measured at discharge. The work-station 10 was operated automatically using a feedback mechanism by which charging was terminated on exceeding a predetermined temperature, when the battery approached its full charge, for example. The discharge was terminated on reaching a predetermined low voltage limit. In this particular experiment, maximal duration was chosen as a second predetermined constraint for both charging and discharging stages.

Each semi-cycle (e.g., charge and discharge phase) was followed by a 0.5 hour rest, when there was no current. All the data including charge and discharge current, voltage, battery state of charge (SOC), internal battery resistance, and temperature, for example, were monitored and stored by DAQ system 5.

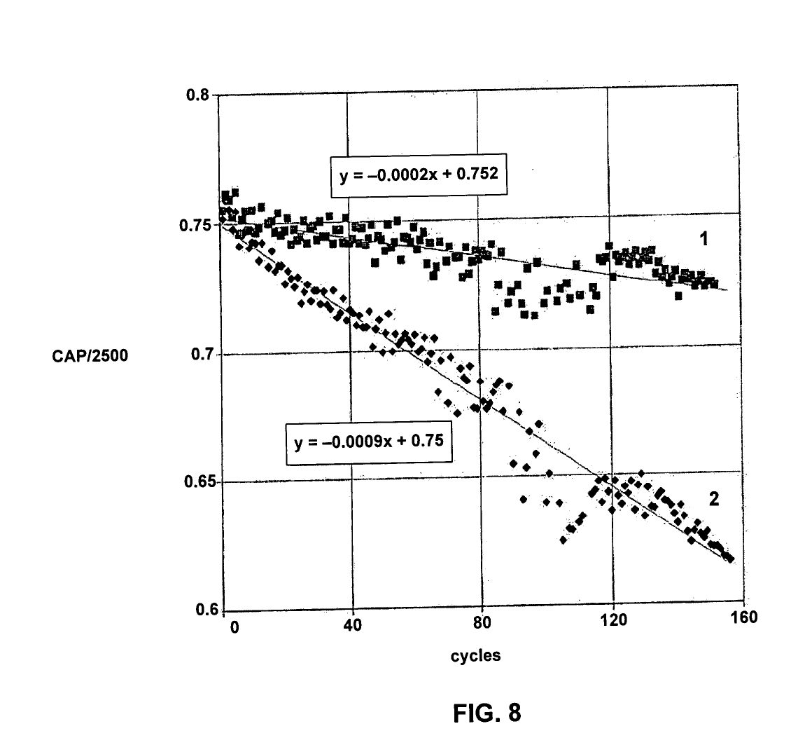

It was found that charging using the superwaves keeping the same charging time substantially improved the battery performance. As shown in FIG. 8, for example, the rate of capacity deterioration for the tested battery charged by “SuperWaves” modulated current (curve 1) was four times lower then the rate of capacity deterioration for the reference battery that was charged by DC (curve 2). In this experiment, for example, the average charge current was about 500 mA, while the discharge current was about 400 mA.

Thus, the life-time of the battery charged by a “SuperWaves” amplitude and frequency modulated current can be significantly prolonged relative to that attainable using traditional methods of charging.

Another aspect of the invention relates to parameters that can be adjusted in response to feedback signals, such as the rate of charging, for example. A battery state of charge (SOC) detector for rapid charging may provide an efficient means for formatting, charging, and recharging batteries of various types and ratings, as set forth in Reipur et al. U.S. Pat. No. 5,686,815, Ding et al. U.S. Pat. No. 6,094,033 and Koenck U.S. Pat. No. 6,075,342, for example, each of which is incorporated by reference herein in its respective entirety.

The detector may determine the SOC of the battery to be charged and then may select an optimal charging signal profile based on the SOC determination. During the charging process, the detector can continuously monitor battery SOC in order to select appropriate waveforms for the charging signal. The charging signal may be superwaves with the amplitude, pulse width, and/or frequency of each charging pulse being selected based upon the detected battery SOC. Predetermined battery parameters, including, but not limited to, the charging voltage potential placed across the battery terminals, the charging current supplied to the battery, equivalent circuit capacitance and resistance, electrochemical overcharge, maximum/minimum battery temperature, and maximum/minimum battery internal pressure, among others, also can be compared with monitored values during the battery charging process to control the charging signal in order to avoid battery damage. The charging process may be continued until detected battery SOC reaches 100% or until charging logic indicates that the charging process should be stopped.

As another example, the system may automatically identify battery type and progressively increase charging current while monitoring for an increase in battery terminal voltage to ascertain the level of load current. The battery temperature may be brought into a relationship to surrounding temperature such that by applying a suitable overcharge current value and observing any resultant temperature increase, the level of remaining battery charge can be determined. For example, if the battery is found to be relatively fully discharged, a relatively high fast-charge rate may be safely applied while monitoring battery temperature.

A wave pattern, as shown in FIG. 6 (although it is to be understood that many others are possible and considered within the scope of the invention), may be interchanged in response to feedback from a circuit (not shown) to determine the charge gradient in a continuous, semi-continuous, or periodic fashion, for example.

What is claimed:

1. A method of charging a rechargeable battery, the method comprising:
applying amplitude and frequency “SuperWaves” modulated electrical power to the battery;
monitoring at least a first characteristic parameter of the charging process during the charging;
comparing at least the first characteristic parameter with corresponding stored sets of reference parameters representing fully charged battery conditions;
selecting, based on the comparison, one of the stored sets of reference parameters; and
terminating the charging process when at least the first characteristic parameter has reached the one of the stored sets of reference parameters.

2. The method of claim 1, wherein at least the first characteristic parameter is the battery temperature and a second characteristic is the average voltage derivative.

3. The method of claim 1, wherein the charging process is terminated if the measured value of at least the first characteristic parameter exceeds a predetermined value for the respective parameter.

4. The method of claim 1, wherein the charge state of the battery is maintained after termination of the charging process by feeding a trickle “SuperWaves” modulated current to the battery to maintain the battery charge.

5. An apparatus for charging a rechargeable battery, the apparatus comprising:
a programmable or pre-programmable power supply able to generate an amplitude and frequency “SuperWaves” modulated current;
means for monitoring at least one characteristic parameter of a charging process during the charging;
means for terminating the charging on exceeding a predetermined parameter indicative of the battery approaching its full charge; and
means for providing a trickle “SuperWaves” charging after the battery is fully charged.
